(19) United States
(12) Patent Application Publication
(10) Pub. No.: US 2017/0363214 A1
(43) Pub. Date: Dec. 21, 2017

(54) Valve device in a motor vehicle

(71) Applicant: Continental Automotive GmbH, Hannover (DE)

(72) Inventors: Rainer Johannes MONTIGNY, Bad Soden (DE); Peter KOHLEN, Regensburg (DE)

(21) Appl. No.: 15/536,895

(22) PCT Filed: Dec. 15, 2015
(86) PCT No.: PCT/EP2015/079790

§ 371 Date: Jun. 16, 2017

(30) Foreign Application Priority Data
Dec. 19, 2014 (DE) 10 2014 226 724.2

(51) Int. Cl. F16K 1/226; F16K 31/04; H01M 8/04

(52) U.S. Cl. CPC F16K 1/2261; H01M 8/04; F16K 31/047; H01M 2250/20

(57) ABSTRACT

A valve device for a fuel cell arrangement in a motor vehicle includes: a housing; a flow duct extending in the housing; a shaft mounted rotatably in the housing; a flap configured to influence the flow cross section of the flow duct, wherein the flap is arranged on the shaft, and coupled to an electric motor and a gear mechanism; a valve seat arranged in the flow duct; and a seal arranged on a radially encircling edge of the flap such that the seal is in contact with the valve seat when the flap is in a closed position, and such that the shaft penetrates the flap at an angle. The shaft with the flap arranged thereon is movable by the electric motor only via the gear mechanism and movement of the flap is blocked in all other cases due to a frictional force generated by the seal.

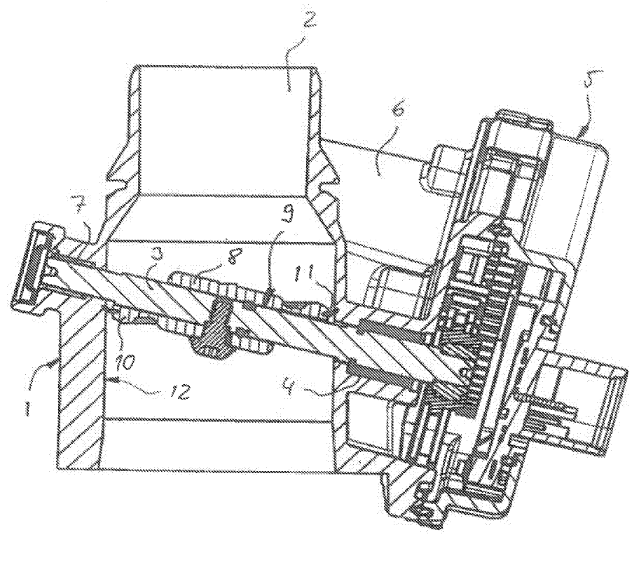

### CROSS-REFERENCE TO RELATED APPLICATIONS

This is a U.S. national stage of application No. PCT/EP2015/079790, filed on 15 Dec. 2015, which claims priority to the German Application No. 10 2014 226 724.2 filed 19 Dec. 2014, the content of both incorporated herein by reference.

### BACKGROUND OF THE INVENTION

### 1. Field of the Invention

The invention relates to a valve device for a fuel cell arrangement in a motor vehicle having a flow duct, which extends in a housing, a flap, which influences the flow cross section. The flap is arranged on a shaft, an electric motor and a gear mechanism, wherein the shaft is mounted rotatably in the housing. A valve seat is arranged in the flow duct, and a seal is arranged on a radially encircling edge of the flap and is in contact with the valve seat in the closed position of the flap, with the result that the shaft penetrates the flap at an angle.

### 2. Related Art

Valve devices are known. Owing to the flowing media, e.g., air, the control elements of the valve must provide a high leaktightness when closing the flow duct. Moreover, the elements should ensure good controllability of the flow cross section of the flow duct and hence of the mass flow of the flowing medium. Particularly as regards leaktightness, conventional valve arrangements of the kind known as throttle valve actuators are disadvantageous since the leaktightness requirements can be 10 to 20 times higher in the case of fuel cell applications, depending on the design. As a result, such valve devices are of complex construction and therefore relatively expensive. It is a known characteristic of throttle valve actuators, in particular, that the shaft is connected to a spring that moves the flap into an emergency running position when the valve device is deenergized, e.g., if the drive fails. This, in turn, has the result that such throttle valve actuators have to be continuously energized if the flap is to be held in a position other than the emergency running position.

### SUMMARY OF THE INVENTION

It is therefore an object of the invention to provide a valve device that will enable the flap to be held in any position without electric power.

According to an aspect of the invention, this object may be achieved by virtue of the fact that the shaft with the flap arranged thereon can be moved by the electric motor only via the gear mechanism and is blocked in all other cases on account of the frictional force generated by the seal.

The provision of a seal having such a high frictional force that the shaft, with the flap arranged thereon, can be driven only by the electric motor and the interposed gear mechanism has the advantage that the flap can be positioned in any possible position and remains in this position, even when the electric motor is deenergized. As a result, no power is required when the flap remains in one of the positions. Therefore the valve device according to this aspect of the invention has a particularly low power consumption. Moreover, the otherwise customary spring can be eliminated, making the valve device less expensive.

In advantageous embodiments, the seal is composed of PTFE (polytetrafluoroethylene) or an elastomer, such as rubber. In this case, the seal is made stiffer so that it develops a higher retaining force in the deenergized state of the electric motor.

### BRIEF DESCRIPTION OF THE DRAWINGS

The invention is described in greater detail by an illustrative embodiment.

The single FIGURE shows: a valve device according to an embodiment of the invention.

### DETAILED DESCRIPTION OF THE PRESENTLY PREFERRED EMBODIMENTS

The valve device for a motor vehicle in the FIGURE comprises a housing 1, with a flow duct 2 arranged in the housing to allow a fluid to flow through. In the present case, it is an air flow that is controlled by the valve device. Arranged in the flow duct 2 is a shaft 3, which is supported in the housing 1 at both ends. A first bearing 4 is situated on the side of the housing 1 on which a gear mechanism 5 is arranged. On the output side, the gear mechanism 5 is connected to the shaft 3 and, on the input side, is connected to an electric motor (not shown), which is accommodated in a separate chamber 6 of the housing 1. A second bearing 7 for the shaft 3 is situated on the side of the flow duct 2 opposite from the gear mechanism 5. Arranged on the shaft 3 is a flap 8, which has a hole 9, through which the shaft 3 extends. To secure the flap 8 on the shaft 3, the flap 8 is screwed to the shaft 3 by a screw 13. The flap 8 furthermore has a radially encircling edge 10, on which a seal 11 is arranged. In the illustration shown, the flap 8 is in the closed position, and therefore the seal 11 interacts with that region of the flow duct 2 that acts as a valve seat 12 and completely closes the flow duct 2. The seal 11 is composed of PTFE and is of relatively stiff design, with the result that it generates a high frictional force.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-3. (canceled)

4. A valve device for a fuel cell arrangement in a motor vehicle, the valve device comprising:
a housing;
a flow duct extending in the housing;
a shaft mounted rotatably in the housing;
a flap configured to influence the flow cross section of the flow duct, wherein the flap is arranged on the shaft, and coupled to an electric motor and a gear mechanism;
a valve seat arranged in the flow duct; and
a seal arranged on a radially encircling edge of the flap such that the seal is in contact with the valve seat when the flap is in a closed position, and such that the shaft penetrates the flap at an angle,
wherein the shaft with the flap arranged thereon is movable by the electric motor only via the gear mechanism and movement of the flap is blocked in all other cases due to a frictional force generated by the seal.

5. The valve device as claimed in claim 4, wherein the seal comprises polytetrafluoroethylene (PTFE).

6. The valve device as claimed in claim 4, wherein the seal comprises an elastomer.
